(19) United States
(12) Patent Application Publication
(10) Pub. No.: US 2022/0025851 A1
(43) Pub. Date: Jan. 27, 2022

(54) ENERGY PRODUCTION APPARATUS

(71) Applicant: DIMITRIOS KOLIOS, North Bay (CA)

(72) Inventor: DIMITRIOS KOLIOS, North Bay (CA)

(21) Appl. No.: 17/380,709

(22) Filed: Jul. 20, 2021

Related U.S. Application Data
(60) Provisional application No. 63/054,418, filed on Jul. 21, 2020.

(51) Int. Cl. F03D 3/04; F03D 9/25; F03D 3/00; F03D 3/06

(52) U.S. Cl. CPC F03D 3/0409; F03D 3/068; F03D 3/005; F03D 9/25

(57) ABSTRACT

The apparatus comprises: a cylinder having an opening presenting perpendicular to a flow of air in use such that, in use, air flows through the cylinder; and means for generating power based upon the flow of air through the cylinder.

### CROSS REFERENCE TO RELATED APPLICATION

This application claims priority upon U.S. Provisional Patent Application 63/054,418 filed Jul. 21, 2020.

### FIELD

The invention relates to devices, such as alternators, for generating power for use with moving vehicles.

### BACKGROUND

In the automotive field, it is ubiquitous for an alternator to be powered by the engine; the power from the alternator is used to charge the battery and power the electronics of the vehicle. However, alternators have significant drag.

### SUMMARY OF THE INVENTION

Forming one aspect of the invention is apparatus for use with a flow of air, the apparatus comprising:
a pair of cylinders, each having an axis and a pair of ends, the cylinder being disposed in use such that:
   one of the pair of ends is in the air flow and the other of the pair of ends is not; and
   the axis is disposed substantially perpendicular to the direction of air flow;
for each cylinder, a piston mounted in said each cylinder for axial reciprocating motion;
for each cylinder, a butterfly valve disposed adjacent the one of the pair of ends;
a linkage coupled to the pistons and the butterfly valves such that:
   as one of the pistons moves from the end in the air flow to the end not in the air flow, the other of the pistons moves from the end not in the air flow to the end in the air flow;
   each butterfly valve closes as the plunger reaches the end of the cylinder in the air flow and opens as the plunger reaches the end of the cylinder not in the air flow; and
a generator driven by the linkage to produce electricity.

Forming another aspect of the invention is apparatus for use with a flow of air, the apparatus comprising:
a cylinder having an opening presenting perpendicular to the flow of air such that, in use, air flows through the cylinder; and
means for generating power based upon the flow of air through the cylinder.

### BRIEF DESCRIPTION OF THE FIGURES

FIG. 1 shows apparatus according to one embodiment of the invention.

### DETAILED DESCRIPTION

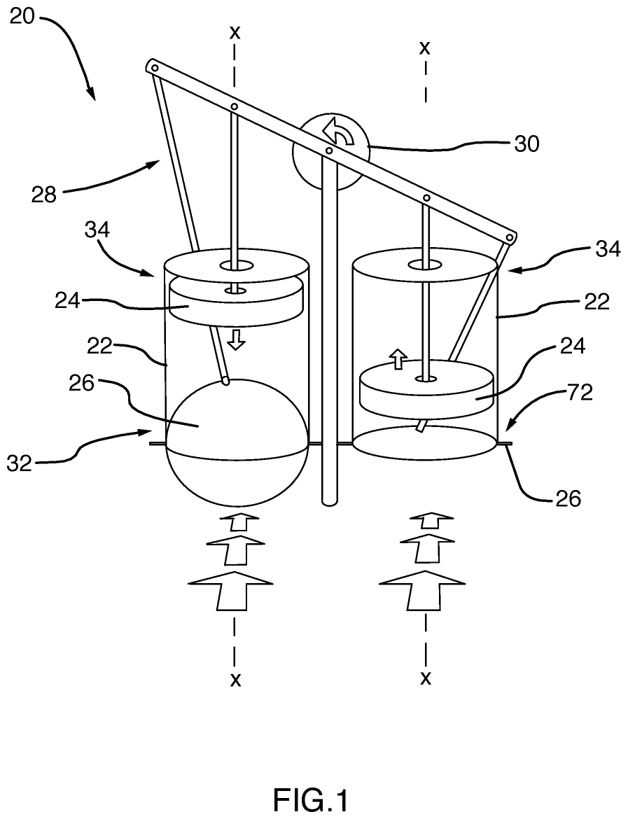

Apparatus 20 according to an embodiment of the invention is shown in FIG. 1 and will be seen to comprise a pair of cylinders 22, a pair of pistons 24, a pair of butterfly valves 26, a linkage 28 and a generator 30.

The cylinders 22 each have an axis X-X and a pair of ends 32,34.

The pistons 24 are provided one for each cylinder and mounted therein for axial reciprocating motion.

The butterfly valves 26 are provided one for each cylinder and are disposed adjacent one 32 of the pair of ends of said each cylinder.

The linkage 28 is coupled to the pistons and the butterfly valves such that:
as one of the pistons moves from the one 32 of the pair of ends to the other 34 of the pair of ends, the other of the pistons moves from the other of the pair of ends to the one of the pair of ends;
each butterfly valve closes as the plunger reaches the one 32 of the pair of ends and opens as the plunger reaches the other 34 of the pair of ends.

The generator 30 is adapted to be driven by the linkage 28 to produce electricity.

In use, the cylinders 22 are disposed in an air flow such that: the one of the pair of ends is in the air flow and the other of the pair of ends is not; and the axis is disposed substantially perpendicular to the direction of air flow.

Apparatus according to an embodiment of the invention was exposed to a 55 mph air flow, with two cylinders disposed at approximately 70° to the air flow, and produced 2.64 watts of energy. The cylinders were 1.5 inches in diameter and 12 inches long and the pistons were each 3.3 oz. This apparatus is shown in U.S. Provisional Application Ser. No. 63/054,418 filed Jul. 21, 2020, incorporated herein by reference.

Without intending to be bound by theory, inventor postulates that the pistons are urged into motion when in communication with atmosphere (via open butterfly valves) via the Bernoulli effect, and that the power available will vary with differential velocity, i.e. the speed of the fluid past the ends of the cylinders exposed in the stream.

Persons of ordinary skill in the art will readily appreciate that the apparatus has many uses. Apparatus of this type could, for example, be disposed on the undercarriage of a road vehicle, and used to charge a battery.

Other uses, as well as variations to the apparatus are possible. Accordingly, the invention should be understood to be limited only by the accompanying claims, purposively construed.

1. Apparatus for use with a flow of air, the apparatus comprising:
a pair of cylinders, each having an axis and a pair of ends, the cylinder being disposed in use such that:
one of the pair of ends is in the air flow and the other of the pair of ends is not; and
the axis is disposed substantially perpendicular to the direction of air flow;
for each cylinder, a piston mounted in said each cylinder for axial reciprocating motion;
for each cylinder, a butterfly valve disposed adjacent the one of the pair of ends;
a linkage coupled to the pistons and the butterfly valves such that:
as one of the pistons moves from the end in the air flow to the end not in the air flow, the other of the pistons moves from the end not in the air flow to the end in the air flow;
each butterfly valve closes as the plunger reaches the end of the cylinder in the air flow and opens as the plunger reaches the end of the cylinder not in the air flow;
a generator driven by the linkage to produce electricity.

2. Apparatus for use with a flow of air, the apparatus comprising:
a cylinder having an opening presenting perpendicular to the flow of air such that, in use, air flows through the cylinder; and
means for generating power based upon the flow of air through the cylinder.
